(19) United States
(12) Patent Application Publication
(10) Pub. No.: US 2017/0354007 A1
(43) Pub. Date: Dec. 7, 2017

(54) TEMPERATURE CORRECTION FOR ENERGY MEASUREMENT IN A STREET LIGHTING LUMINAIRE

(71) Applicant: General Electric Company, Schenectady, NY (US)

(72) Inventor: Jean-Francois SAMSON, Lachine (CA)

(21) Appl. No.: 15/425,498

(22) Filed: Feb. 6, 2017

Related U.S. Application Data
(60) Provisional application No. 62/346,419, filed on Jun. 6, 2016.

(51) Int. Cl. H05B 33/08; F21S 8/08; F21V 23/00; F21Y 2115/10

(52) U.S. Cl. CPC H05B 33/0851; F21V 23/003; F21S 8/086; F21Y 2115/10

(57) ABSTRACT

A street lighting assembly includes an LED lighting device and a node assembly coupled to the LED light device. The node assembly includes a processor, the processor being configured to detect a temperature within an operating environment of the LED light device, determine a correction factor associated with the detected temperature, and apply the correction factor to one or more measured values of electrical parameters of the LED light device.

### FIELD

The aspects of the present disclosure relate generally to street lighting fixtures. In particular, the aspects of the disclosed embodiments are directed to energy measurement in a street lighting fixture.

### BACKGROUND

Street lighting lamps or luminaires are generally designed for long life operation. The typical street lamp will generally include a weather proof, robust, cast aluminium housing that is mounted on a pole. The lighting components, such as a light source, electrical driver, other optics, electrical components and devices are incorporated into the aluminium housing. As the street lamp is typically outdoors, the street lamp and the components within the housing will be subjected to a variety of environmental conditions, such as variations in temperature.

In an uncontrolled or unregulated environment, the street lamp and the components within the interior of the housing of the street lamp can be subject to a range of different temperatures. Example of these temperatures can range from approximately −40 degrees Celsius to and including approximately +50 degrees Celsius. In some cases, temperatures as high as +85 degrees Celsius have been realized. This temperature range is merely exemplary, and it will be understood that the different environments where a street lamp can be used and is located will vary in terms of temperature.

Electronic components and device, such as LEDs and LED drivers, and the performance of these components, can be affected by changes in temperature. Electronic devices are generally configured to provide a certain level of performance or output at predetermined temperatures or temperature ranges. For example, with respect to an LED, the cooler the environment, the higher the light output of the LED will tend to be. At higher temperatures, the light output of the LED tends to be reduced. Further, in warmer environments and at higher currents, the temperature of the semiconducting element of the LED tends to increases. The light output of an LED for a constant current will tend to vary as a function of its junction temperature.

The measurement of the electrical performance of an LED lamp, such as a street lamp, will tend to vary as a function of the temperature of the environment within which the LED lamp is operating. Measurement variables such as current, voltage, active power, reactive power and energy will be dependent upon the temperature of the environment within which the LED lamp(s) is operating. The environmental temperature impacts the operational temperature and performance of an LED lamp. It would be advantageous to be able to minimize and/or remove the effects of temperature and temperature offset in the measurement of the performance of a street lamp.

Accordingly, it would be desirable to provide an LED street lighting assembly that addresses at least some of the problems identified above.

### SUMMARY

As described herein, the exemplary embodiments overcome one or more of the above or other disadvantages known in the art. One aspect of the exemplary embodiments relates to a street lighting assembly. In one embodiment, the street lighting assembly. The street lighting assembly includes an LED lighting device and a node assembly coupled to the LED light device. The node assembly includes a processor, the processor being configured to detect a temperature within an operating environment of the LED light device, determine a correction factor associated with the detected temperature, apply the correction factor to one or more measured values of electrical parameters of the LED light device and adjust the one or measured values of electrical parameters of the LED light device for an offset based on temperature.

Another aspect of the exemplary embodiments relates to a method. In one embodiment, the method includes determining a temperature of an operating environment for an electronic device; measuring one or more electrical parameters associated with an operation of the electronic device in the operating environment; and using a processor to execute machine readable instructions stored in a memory device, the machine readable instructions when executed by the processor being configured to cause the processor to: determine a correction factor associated with the determined temperature; and apply the determined correction factor to the one or more electrical parameters associated with the operation of the electronic device in the operating environment to adjust the measured electrical parameters for a temperature offset.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 illustrates an exemplary street light assembly incorporating aspects of the disclosed embodiments.

FIG. 2 is a flowchart illustrating a process incorporating aspects of the disclosed embodiments.

FIG. 3 is another exemplary street light assembly incorporating aspects of the disclosed embodiments.

FIG. 4 illustrates an exemplary circuit board for a street light assembly incorporating aspects of the disclosed embodiments.

FIG. 5 is a flow chart of an exemplary process incorporating aspects of the disclosed embodiments.

FIG. 6 is an exemplary curve of energy measurement error as a function of temperature.

FIG. 7 illustrates an exemplary corrector function for a street lighting assembly incorporating aspects of the disclosed embodiments.

FIG. 8 is an exemplary node assembly for a street light assembly incorporating aspects of the disclosed embodiments.

FIG. 9 illustrates an exemplary wireless control system for street and roadway light assemblies incorporating aspects of the disclosed embodiments.

FIG. 10 illustrates another example of a node assembly for a street light assembly incorporating aspects of the disclosed embodiments.

FIG. 11 illustrates an exemplary architecture that can be used to practice aspects of the disclosed embodiments.

### DETAILED DESCRIPTION OF THE EXEMPLARY EMBODIMENTS OF THE DISCLOSURE

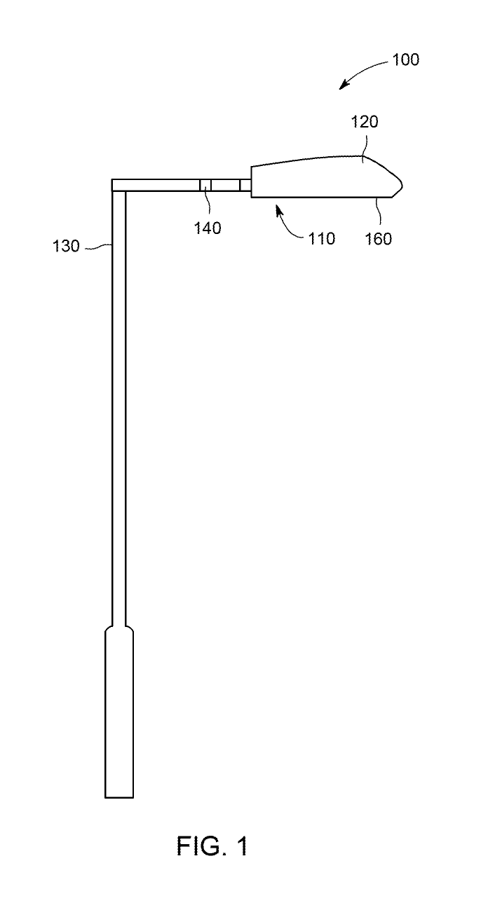

FIG. 1 illustrates one embodiment of a street light or lamp assembly 100 including aspects of the disclosed embodiments. The aspects of the disclosed embodiments are generally directed to correcting for the effects that the temperature of the environment in which an electrical device or component is located has on the measurement of one or more electrical performance parameters of the device. The aspects of the disclosed embodiments will generally be described herein with respect to a street light assembly, such as for example an LED street light assembly. By correcting for the effect that the temperature of the environment where the LED street light assembly is located has on measured electrical performance parameters, improved accuracy can be realized in the measuring the performance of the LED street light assembly.

Although the aspects of the disclosed embodiments are described herein with respect to a street light assembly, the aspects of the disclosed embodiments are not so limited. The aspects of the disclosed embodiments can be applied to any electrically powered or electronic equipment, generally referred to herein as a “device” or “equipment”, where the ambient temperature of the environment where the device is located can have an effect on the measurement, or measurement results, of electrical performance parameters such as current, voltage, power and energy.

In the example of FIG. 1, the exemplary street light assembly 100 generally includes a light or lamp assembly 110, a housing 120, and a pole 130. In the example of FIG. 1, the light assembly 110 and housing 120 are coupled to the pole 130. Although the aspects of the disclosed embodiments are generally described herein with respect to the light assembly 110 being mounted on a pole 130, the aspects of the disclosed embodiments are not so limited. The pole 130 is configured to secure the light assembly 100 in place, such as in the ground or a stationary structure such as a wall or post member. In alternate embodiments, the light assembly 110 can be mounted to any suitable structure, such as a building, for example, without a pole member 130.

In one embodiment, the light assembly 110, which may also be referred to as a luminaire, is disposed or contained within the housing 120. As is illustrated in FIG. 1, in one embodiment, the light assembly 110 includes or is coupled to a modular connector unit 140. The modular connector unit 140 is used to couple or connect at least a light portion 160 of the light assembly 110 to the pole 130, depending on the particular configuration. The modular connector unit 140 can include the electrical connection from the mains power to provide electrical power to the light assembly 110.

The light assembly 110 includes a light portion 160. The light portion 160 generally comprises or includes an LED light or LED lighting assembly, also referred to as an LED module. The LED module will generally be understood to include or provide the electrical power and signalling to activate the light portion 160. For the purposes of the description herein, the light portion 160 will generally include the electronic components and devices that are typically associated with an LED luminaire. These components can include, for example, but are not limited to, an LED light cluster (comprising one or more LEDs) assembled to or sealed on one or more of a circuit board panel, a heat sink, and an LED driver or power supply. The light portion 160, and the electrical components associated therewith, will generally be disposed within the housing 120.

As will be understood, during a typical operation, the environment outside the housing 120 can be at one temperature, while the temperature inside the housing 120 can be at another temperature. The aspects of the disclosed embodiments are configured to determine the temperature of the environment in which the light portion 160 is operating, and provide a correction factor to be applied to the results of the measurement of electrical performance parameters of the light portion 160 to remove any offset introduced into the measurement results. The electrical parameters that are measured can include but are not limited to, current voltage, active power, reactive power and energy. The measurement of these exemplary parameters is dependent upon the temperature of the environment and will be affected whenever the digital system, in this case the light assembly 100, operates in an outdoor environment. By correcting for temperature, more accurate electrical performance and measurement results in such a digital system can be provided.

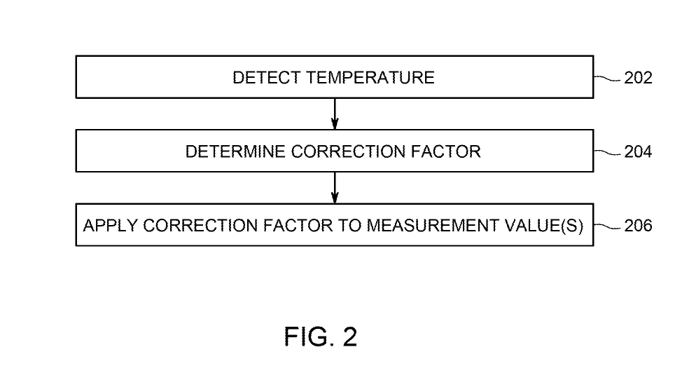

FIG. 2 illustrates an exemplary process incorporating aspects of the disclosed embodiments. In one embodiment, the temperature of the environment in which the device, such as the street light assembly 100, is operating is determined 202. Generally, as will be described further herein, with respect to the street light assembly 100, the temperature within the housing 120 in which the various electronic components of the light portion 160 are disposed is determined 202. In one embodiment, as will be described further herein, the electronic components comprise digital electronic components.

For example, in the case of the street light assembly 100 referenced in FIG. 1, the street light assembly 100 is typically operating in an outdoor environment. As noted above, the temperature of the environment in which the street light assembly 100 is operating can range from approximately −40 degrees Celsius to and including +85 degrees Celsius. When electrical parameters such as current, voltage and power of the street light assembly 100 are measured, the results can be affected by the environmental temperature.

In one embodiment, once the temperature is determined 202, a correction factor or offset related to the determined temperature is determined 204. The correction factor is then applied 206 to the measured values. In one embodiment, applying the correction factor comprises using a digital corrector device to apply a non-linear correction algorithm to the measurement results. In this manner, the aspects of the disclosed embodiments correct for the effect of temperature on measured values related to the performance and output of a device such as the street light assembly generally disclosed herein.

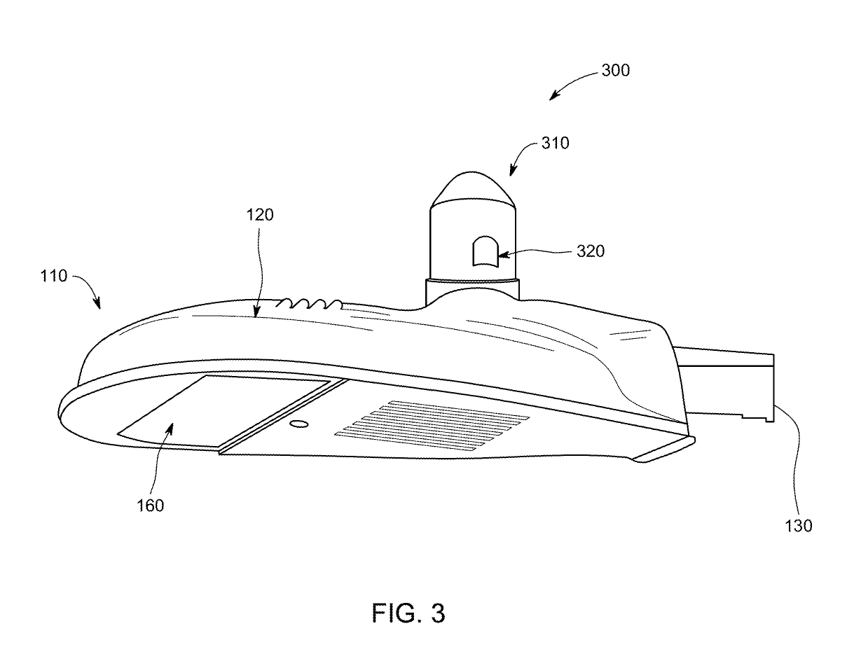

FIG. 3 illustrates another example of an exemplary street light assembly 300 incorporating aspects of the disclosed embodiments. In this example, the street light 300 includes a node assembly 310 that is disposed on the housing 120. As will be described further below, the node assembly 310 is generally configured to collect measurement data pertaining to the operation of the light assembly 110 and correct the measurement data based on the temperature within the housing 120, as is generally described herein. Although the node assembly 310 is shown disposed on a top portion of the housing 120, the aspects of the disclosed embodiments are not so limited. In alternate embodiments, the node assembly 310 can be disposed on any suitable portion of the street light assembly 300, including within the street light assembly 300.

In one embodiment, the node assembly 310 includes a digital corrector device or circuit 320. The digital corrector device 320 is generally configured to determine and provide the correction offset that is needed to adjust the measured electrical values related to the street light assembly 300. This improves the accuracy of the measurements. In one embodiment, the digital corrector device 320 comprises or is part of a processor or controller, as will be generally described herein.

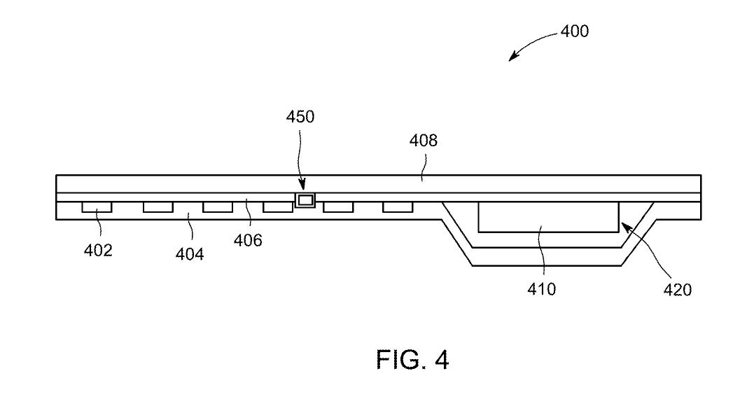

Referring also to FIG. 4, in one embodiment, the light portion 160 can also include or be electrically coupled to a driver or power supply for the LED module of the light assembly 110. In one embodiment, the driver or power supply, also referred to as the LED driver, together with the other electrical components comprising the LED module, can be disposed on a printed circuit board 406 of the light portion 160 as is described with respect to FIG. 4. In one embodiment, as is described further herein and shown in FIG. 4, both the LED module and the LED driver can be disposed on the printed circuit board 406 in a manner as is generally understood.

Referring to FIG. 4, one embodiment of an exemplary electronics assembly 400 for the LED light assembly 110 and lighting module 160 of FIG. 1 is illustrated. For the ease of the description herein, in the example of FIG. 4, the electronics assembly 400 is in the form of electrical and electronic components disposed on a printed circuit board 406. In alternate embodiments, the electrical and electronic components for the LED light assembly 110 can be configured in any suitable manner, other than including on a printed circuit board.

In the example of FIG. 4, the assembly 400 includes at least one LED module 402, a front lens portion 404, also referred to as an optical cover part 404, the printed circuit board 406 and an LED driver module 410. In one embodiment, the LED light assembly 110 can include a heat sink 408 that is coupled to or part of the printed circuit board 406. In alternate embodiments, the assembly 400 can include any other suitable electronic components, other than including those for an LED light assembly 110.

The LED module 402 can comprise one or more LED chips or an array of LED chips. In the example of FIG. 4, there are six LED modules 402, which may be referred to as an LED array. In alternate embodiments, any suitable number of LED modules 402 can be included, other than including six. For example, only one LED module 402 may be provided, the LED module 402 including one or more LED chips. The aspects of the disclosed embodiments are not limited by the number of LED modules 402 or chips that are incorporated in the LED assembly 400.

The LED driver 410, also referred to as a power supply, is generally configured to provide the electrical power and signals needed to operate the LED module(s) 402, as was generally described with respect to FIG. 1. The aspects of the disclosed embodiments allow the LED driver 410 to be suitably positioned with the LED module(s) 402, such as on the printed circuit board 406. Alternatively, the LED driver 410 can be disposed within any suitable portion of the housing 120. For example, the LED driver 410 can be disposed on a separate printed circuit board.

In the example of FIG. 4, the LED driver 410 can include a digital corrector device or module 320 incorporating aspects of the disclosed embodiments. The digital corrector device 320 is generally configured to correct for an offset in the measurement of current, voltage, active power, reactive power and energy due to the ambient temperature, and provide more accurate measurement results. In alternate embodiments, the digital corrector device 320 can be disposed in any suitable location with respect to the light assembly 110. For example, referring to the example in FIG. 3, the digital corrector device or module 320 can be part of, or included in the node assembly 310. In this manner, the light assembly 110 and the light module 160 can be manufactured independently of the digital corrector device 320.

In one embodiment, as will be described below, the node assembly 310 is configured to be removably connected to the light assembly 110, meaning that it can be connected and disconnected without interfering with the general operation of the light assembly 110. In this case, the node assembly 310 would include a suitable connector, such as plug or twist type connector that allows the node assembly 310 to be connected and disconnected from the light assembly 110. Such an embodiment where the digital corrector device 320 is part of the node assembly 310 provides more flexibility in manufacturing,

In one embodiment, one or more temperature sensors 450 are disposed on or in connection with the circuit assembly 400. The temperature sensor(s) 450 is configured to measure or obtain the temperature, or data relating to the temperature of the operating environment of the light assembly 110, and in particular, the light portion 160, to which the measured parameters relate.

As will be described further below, the temperature sensor 450 can be a standalone device, or can also be part of another unit or electronics. The aspects of the disclosed embodiments are not intended to be limited by the manner in which the temperature within the housing 120 is determined or obtained. Generally, the temperature sensor 450 can be any suitable temperature sensor that can be used measure the temperature of the environment in which the light assembly 110 and light module 160 are operating. For example, in one embodiment, the temperature sensor 450 is a thermocouple device. The thermocouple device can be disposed on a suitable portion of the circuit board assembly 400.

Although the aspects of the disclosed embodiments are described with respect to the temperature sensor(s) 450 being disposed on the circuit board assembly 400, the aspects of the disclosed embodiments are not so limited. In alternate embodiments, the temperature sensor(s) 450 can be disposed within or on any part of the light assembly, such as the lighting assembly 100 shown in FIG. 1. For example, in one embodiment, referring to FIG. 1, one or more temperature sensors 450 are disposed on or within the housing 120 in a manner so as to measure the ambient temperature in and around the electrical and electronic components of the light assembly 110. In this manner, the temperature sensor(s) 450 is generally configured to determine the temperature within the housing 120, which is the environment in which the electrical and electronic components of light assembly 110, and in particular the light module 160, are operating.

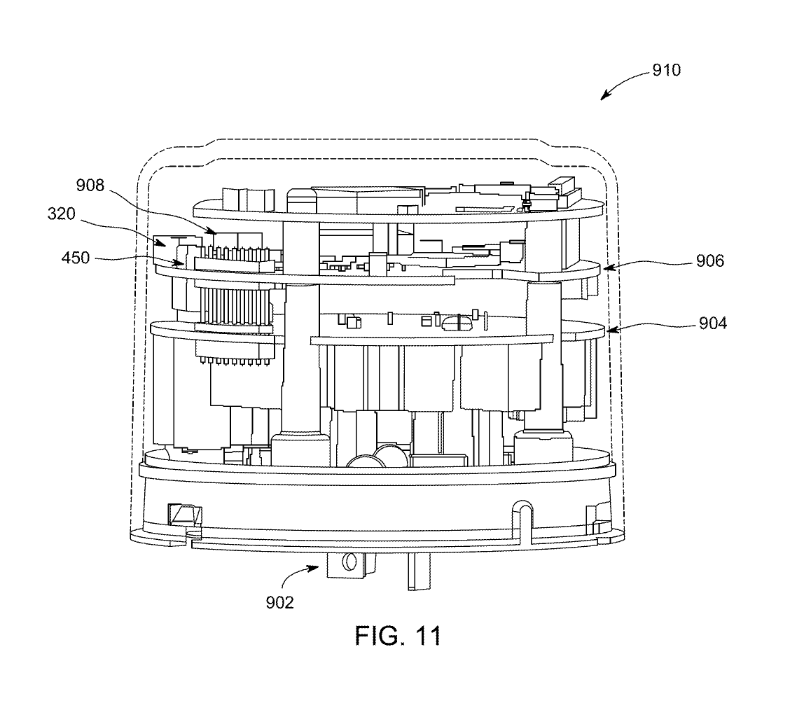

In one embodiment, referring also to FIG. 11, the digital corrector device 320 comprises a processor 1002, such as a microprocessor. When the digital corrector device 320 is disposed in the node assembly 310, the digital corrector device 320 may be or have its own processor. When the digital corrector device 320 is part of the circuit board assembly 400 of FIG. 4, the digital corrector device 320 may be or have its own processor, or share a processor already included in the printed circuit board assembly 400. For example, the processor 1002 can be part of the digital corrector 320 or a standalone device.

Although the aspects of the disclosed embodiments will describe the digital corrector 320 as being part of the LED driver module 410, the aspects of the disclosed embodiments are not so limited. In alternate embodiments, the digital corrector 320 can be a separate electronic circuit, device or module, or be included in or part of another processing device, such as a microprocessor or a controller that comprises or includes the processor. In one embodiment, the temperature sensor(s) 450 generally described above can be included with, or part of the digital corrector device 320.

In one embodiment, the digital corrector device 320 comprises a computer program product disposed on a non-transitory computer readable medium. For example, in this embodiment, the digital corrector 320 is comprised of machine-readable instructions, that when executed by the processor 1002 shown in FIG. 11, are configured to carry out the processes generally described herein.

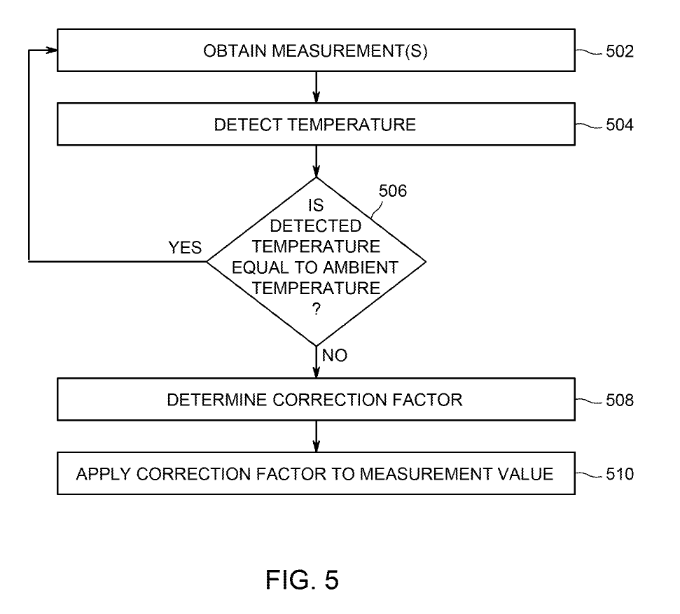

FIG. 5 illustrates an exemplary process incorporating aspects of the disclosed embodiments. In this example, the performance of the street light assembly 100 is being monitored by measuring various electrical parameters. For example, in one embodiment, one or more of the street light assembly 100 and the node 320 can include certain electrical and electrical components, and in particular digital components, that are configured to measure and monitor the electrical consumption of the light assembly 110 in terms of current, voltage, power and energy. In alternate embodiments, any suitable parameters can be measured to monitor the electrical performance of the light assembly 110.

In one embodiment, measurements of one or more electrical parameters of the street light are obtained 502. The measurements can be obtained in any suitable manner. For example, in one embodiment, a measurement unit or circuit, such as a voltmeter or ammeter, can be used to measure the desired parameters of the street light assembly 100. The measurement unit, also referred to as an electrical parameter meter, can be part of the node assembly 320 shown in FIG. 3, part of the electronics shown on the circuit board assembly 400 of FIG. 4, or a separate unit.

A temperature of the environment within which the street light electronics are disposed is obtained or detected 504. The temperature can be obtained in any suitable manner, such as by using the temperature sensor 450. Generally, when the electronics and electrical components are disposed within a housing, such as the housing 120 of FIG. 1, the temperature sensor 450 is configured to detect 504 the temperature within the housing 120.

In one embodiment, it is determined 506 whether the detected temperature is substantially equal to a pre-determined ambient temperature. If the temperature of the environment in which the electronics of street light are operating is within an ambient or expected temperature range, it may not be necessary to apply a correction factor to the measurements. For example, the electronics of the street light assembly 110 may be configured to operate in accordance with certain standard values at a pre-determined temperature or temperature range. In this case, it will be understood that the measured parameters are generally accurate within certain temperature tolerances and ranges, and there may not be a need to apply any correction or offset. Alternatively, even when the street light is operating within a standard or controlled temperature environment, a correction factor can still be determined and applied to the measurement results in the manner as is generally described herein.

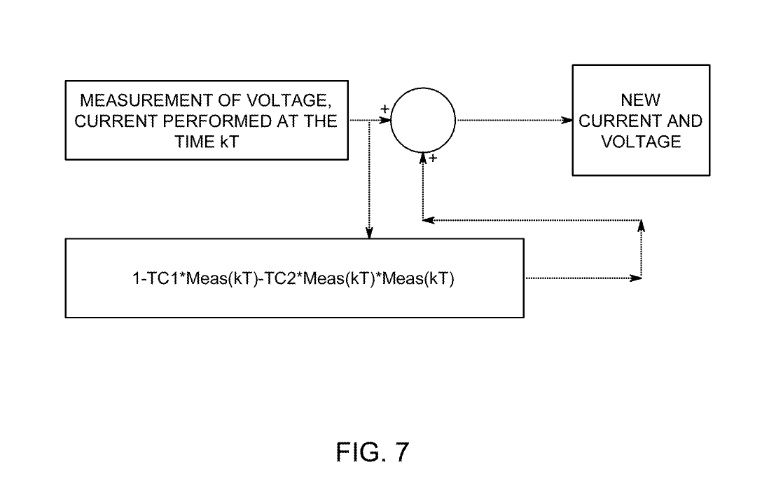

If the detected temperature is not at or within an ambient temperature range, a correction factor to be applied to the measurement results is determined 508. In one embodiment, the correction factor or offset is obtained from a database of correction factors. Alternatively, a corrector function can be applied to the measure values as will be discussed below with respect to FIG. 7. The database can be established by testing the electronics at certain temperatures and then determining a correction factor for each temperature. These correction factors or values can be stored in a memory device and retrieved as needed. In alternate embodiments, the correction factors can be determined and stored in any suitable manner.

In one embodiment, the database of correction factors can be stored on a memory 1004 of the street light assembly 100, with reference to FIG. 11. In alternate embodiments, the database of correction factors can be stored in any suitable facility. For example, the street light assembly 300 can include communication capabilities that allow it to request and download the correction factors when desired.

The determined correction factor is then applied 510 to the measurement result(s). In this manner, the results of the measurement of parameters such as voltage, current and power are more accurate. Thus, the power and energy consumption factors of a LED lamp operating in a non-ambient temperature environment are more accurately portrayed.

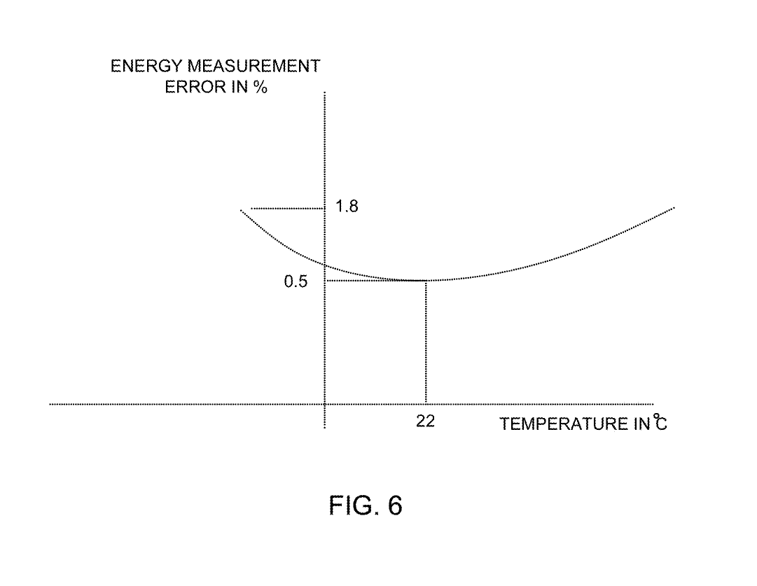

FIG. 6 illustrates an exemplary curve of energy measurement error. In this example, the temperature in degrees Celsius is indicated along the X axis, while the energy measurement error in terms of percentage is shown on the Y axis. The temperature compensation is a digital correction based the feedback from the current and voltage measurements. In the example of FIG. 6, at a temperature of 22 degrees Celsius, the energy measurement error is approximately 0.5 percent. In this example, 1.8 is the maximum error in terms of percentage. It is noted that the energy measurement error can rise relative to both an increase in temperature as well as a decrease in temperature.

The curve of the energy measurement error is a function of the temperature and moreover, it is approximatively a second degree polynomial. This second order function is deduced from an interpolation of the energy error curve. In one embodiment, the energy error is measured with an energy calibrator. The energy calibrator finds application in the street light assembly 100 as is shown in FIG. 1 and can be part of the node assembly 310 and digital corrector device or circuit 320 shown in FIG. 3. The energy calibrator can also be disposed in a home energy or utility meter.

FIG. 7 illustrates an exemplary corrector function for the digital corrector device 320 incorporating aspects of the disclosed embodiments. In this example, the corrector function is a function of a temperature value that is measured as close as possible to the electronics of the lighting assembly 110, and in particular the LED driver. In embodiments where the digital corrector device 320 is implemented in a device other than including a street light assembly, such as an electrical meter, the temperature value that is provided to the digital corrector device 320 is measured at a point as close as possible to the electronic components.

For example, a typical electric utility meter can be located in an outdoor environment. In such an environment, the utility meter is subject to the environment, and the temperature in the specific environment. Thus, electrical parameter measurements taken at the meter can be affected by temperature. It is noted that in this embodiment, the actual electrical components or devices that are operating and consuming power may not be subject to the unregulated temperature in which the meter itself is located. By disposing the digital corrector module 320 with an electric meter, more accurate electricity consumption measurements can be obtained. In this manner, the measurement values can be modified to provide more accurate measurements and adjust for the effect of temperature on the measured values.

In the example of FIG. 7, kT is the time, TC1 and TC2 are the gains of the corrector, and Meas(kT) is an electrical parameter or value measured at the time kT. The exemplary corrector function for digital corrector device 320 of the disclosed embodiments improves the voltage and current measurement, and provides improved accuracy of the energy measurement. In one embodiment, the accuracy of the digital corrector device 320 of the disclosed embodiments, using for example the corrector function illustrated in FIG. 7, can be between −0.5 and +0.5. These improvements in the accuracy of electrical parameter measurements can be realized using the digital corrector device 320 of the disclosed embodiments, even if the electrical and electronic hardware of the lighting assembly 110 or the node 310 changes slightly. In one embodiment, the corrector function shown in FIG. 7 can be implemented in a processor of the digital corrector device 320. Where the processor is embodied or implemented in the form of a chip, or other integrated circuit, the chip can be reprogrammed without the need to change hardware.

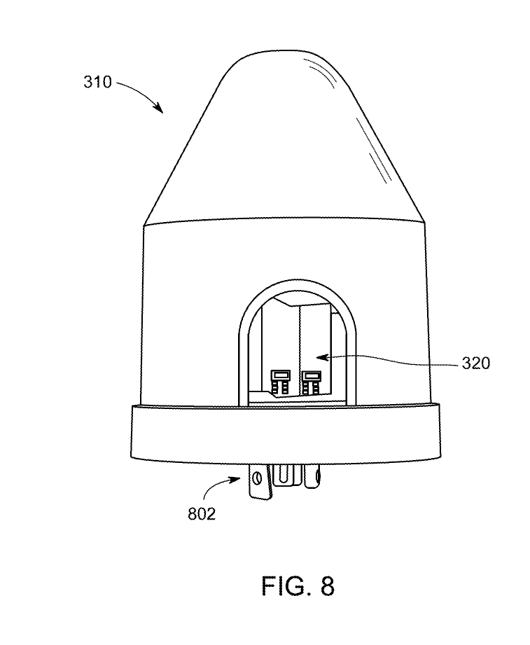

FIG. 8 illustrates one example of the node assembly 310 shown in FIG. 3. Referring also to FIG. 3, the node assembly 310 is configured to connect to the light assembly 110. In the example of FIG. 3, node assembly 310 is plugged into the light assembly 110 in a manner that allows the node assembly 310 to directly couple to or connect with the electrical lines that provide electrical power to the street light assembly 100. The node assembly 310, and in particular the digital corrector device 320, and detect and measure the electrical parameters of the light assembly 110, such as those described herein. Where the device is a utility meter, the utility meter can be configured to allow the node assembly 310 to plug into the utility meter in a manner as is generally described herein.

As shown in the example of FIG. 8, the node assembly 310 includes a connector 802. The connector 802 can comprise a power mains connector that connects or plugs into a suitable receptacle on the top portion of the light assembly 110. The receptacle in the light assembly 110 is coupled or connected to at least the power mains of the light assembly 110.

In one embodiment, the temperature sensor(s) 450 and the digital corrector module 320 can be included in, or part of the node assembly 310. In this example, the sensor 450 and digital corrector device 320 might be disposed on a printed circuit board or such other suitable assembly inside the node assembly 310. In an alternate embodiment, the node 310 can include a processor 1002 that includes or is configured to carry out the functionality and processes of the digital corrector device 320 and temperature sensor 450 as those function and processes are described herein. As an example, in one embodiment, the node assembly 310 can include an integrated circuit or chip, that is specially programmed with the functionality of the digital corrector module 320 as is described herein.

In one embodiment, the node assembly 310 and the digital corrector device 320 can be configured to communicate with a network, in a manner as is generally understood. The network can be wired or wireless. In one embodiment, the digital corrector device 320 is configured to communicate with a database to obtain the offset correction values as are described herein. In one embodiment, the database can be remotely located from the node assembly 310, such as in a server. This can allow of the values in the database to be updated as needed. Alternatively, the offset correction values can be stored in a memory device that is accessible by the node assembly 310 and the digital corrector module 320. The memory or storage device can be part of the digital corrector device 320, or remotely located.

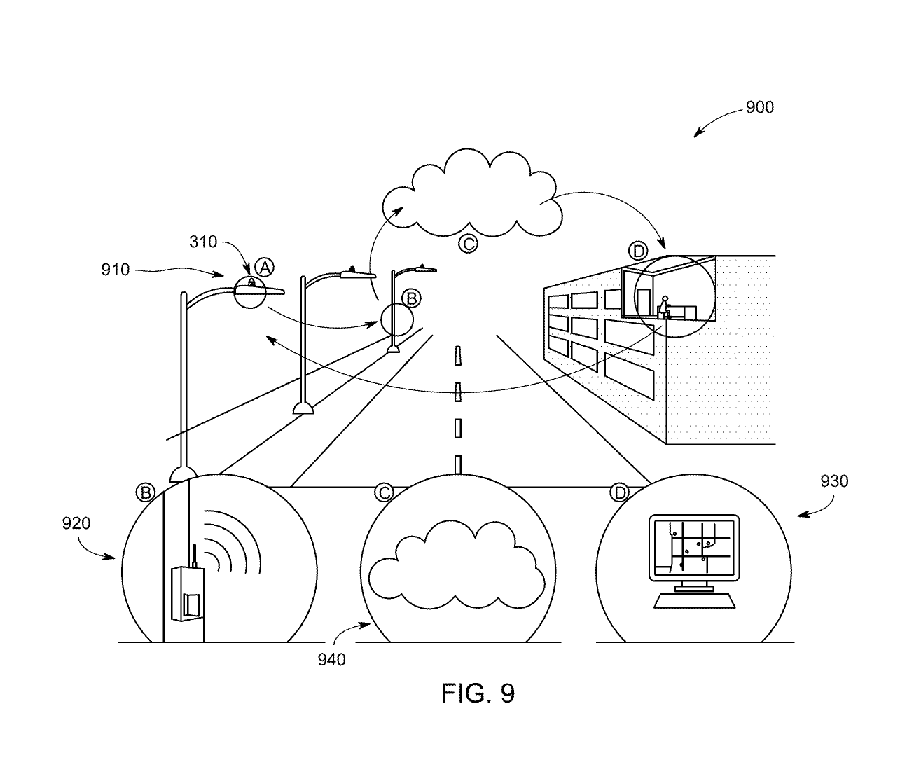

FIG. 9 illustrates one example of a wireless control system 900 for street and roadway lights incorporating aspects of the disclosed embodiments. In this example, the system 900 is configured for the remote operation and monitoring of one or more lighting fixture assemblies 910 through a Web-enabled management system.

In the example of FIG. 9, the node 310 is disposed at the top portion of the light fixture 910 and is configured to collect measurement data and send it to a wireless gateway 920. The light fixture 910 is similar to the light fixture 300 described with respect to FIG. 3. The wireless gateway 920 is configured to communicate with the node assembly 310, transferring specific street light usage and performance data. In one embodiment, the street light usage and performance data includes, but is not limited to measurement parameters for current, voltage, power and energy. These measured parameter values are transmitted or otherwise communicated to the digital corrector device 320, as is otherwise described herein.

In one embodiment, the data can be delivered via a network 930, such as a cellular or Ethernet backhaul, to a server facility. In this manner, the data can be made available to any one of a number of parties or entities. In the example of FIG. 9, the lighting data for each lighting fixture, including the measurement data described herein, can be made available via a Web-based interface 940 that can be hosted remotely, for example. In this manner, authorized users can view the performance of the lighting fixtures.

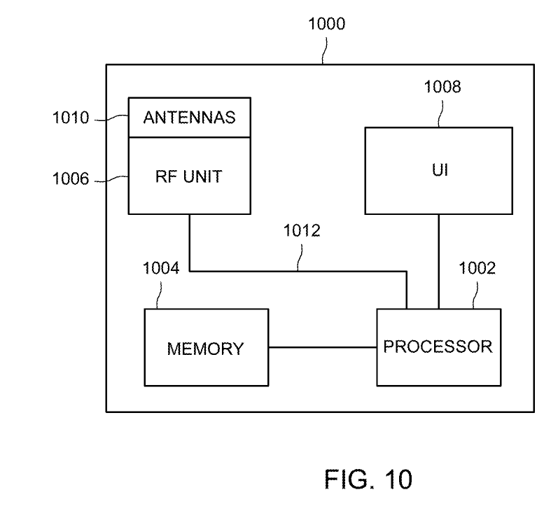

FIG. 10 illustrates another exemplary node assembly 910 incorporating aspects of the disclosed embodiments. In this example, the node assembly 910 is similar to the node assembly 310 described with respect to FIG. 3, and is configured to provide the same or similar functionality. In this example, the interior layout of the node assembly 910 is shown. In the example of FIG. 10, the node assembly 910 includes connector 902, similar to connector 802 in FIG. 8. The node assembly 902 includes printed circuit boards 904, 906 that include electrical and electronic components disposed thereon. For example, the temperature sensor 450 and digital corrector device 320 can be included therein. In one embodiment, the electrical measurement device(s) 908 can be disposed within the node assembly 910. The particular placement of the temperature sensor 450, digital corrector device 320 and measurement device(s) 908 in the node 910 illustrated in FIG. 10 is merely exemplary. In alternate embodiments, the temperature sensor 450, digital corrector device 320 and measurement device(s) 908 can be located in any suitable position within the node 920.

FIG. 11 illustrates a block diagram of an apparatus 1000 that can be used to practice aspects of the present disclosure. The apparatus 1000 is appropriate for implementing embodiments of the digital corrector device and temperature correction process described herein. Individual ones of the apparatus 1000 as described herein can be implemented in or in conjunction with, the node 310 described herein.

The apparatus 1000 generally includes a processor 1002. The processor 1002 may be a single processing device or may comprise a plurality of processing devices including special purpose devices, such as for example digital signal processing (DSP) devices, microprocessors, or other specialized processing devices as well as one or more general purpose computer processors including parallel processors or multi-core processors. The processor 1002 is configured to perform embodiments of the processes described herein.

The processor 1002 is coupled to a memory 1004 which may be a combination of various types of volatile and/or non-volatile computer memory such as for example read only memory (ROM), random access memory (RAM), magnetic or optical disk, or other types of computer memory. The memory 1004 stores computer program instructions that may be accessed and executed by the processor 1002 to cause the processor 1002 to perform a variety of desirable computer implemented processes or methods as are described herein. The program instructions stored in memory 1004 may be organized as groups or sets of program instructions referred to by those skilled in the art with various terms such as programs, software components, software modules, units, etc., where each program may be of a recognized type such as an operating system, an application, a device driver, or other conventionally recognized type of software component. Also included in the memory 1004 are program data and data files which may be accessed, stored, and processed by the computer program instructions.

An RF Unit 1006 can be coupled or connected to the processor 1002. The RF unit can also be coupled to antennas 1010 and is configured to transmit and receive RF signals based on digital data 1013 exchanged with the processor 1002. In transmitter applications, the RF Unit 1006 is configured to receive digital information in the form of digital data 1013 from the processor 1002 and transmit it to one or more receivers such as described with respect to FIG. 9 herein.

In an embodiment of an apparatus 1000 that includes a UI 1008, the UI 1008 may include one or more user interface elements such as a touch screen, keypad, buttons, voice command processor, as well as other elements adapted for exchanging information with a user. The user interface 1008 can be in the form of an indicator to illustrate the operation of the node 310 or even to display certain measurement results as desired.

The aspects of the disclosed embodiments are directed to correcting for the effect temperature has on the measurement of electrical performance parameters of electronic devices, such as an LED street lamp. By providing a digital corrector device that can be removably coupled to the street lamp, the aspects of the disclosed embodiments can adjust or correct for variations in the results of the measurement of electrical parameters, where the temperature affects those results. The device of the disclosed embodiments improves the accuracy of any current, voltage, power and energy measured on a device, such as an LED street lamp.

By implementing the digital corrector device on a node, such as that described herein, the deployment does not require a material change to the LED street lamp. The LED lamp also does not need to be modified to protect the digital components from the temperature variations in order to obtain accurate results. The aspects of the disclosed embodiments also provide for more reliable monitoring of an electrical device such as a street lamp, particularly when it has been in the field a number of years. The aspects of the disclosed embodiments also provide for improved accuracy and reproducibility of the measurements, which can be compared to factory results for monitoring equipment performance.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A street lighting assembly, comprising:
an LED light device; and
a node assembly electrically coupled to the LED light device, the node assembly including a processor, the processor being configured to:
detect a temperature of an operating environment of the LED light device;
determine a correction factor associated with the detected temperature;
apply the correction factor to one or more measured values of electrical parameters of the LED light device; and
adjust the one or measured values of electrical parameters of the LED light device for an offset based on temperature.

2. The street lighting assembly of claim 1, wherein the processor is configured to calculate the correction factor as a function of the detected temperature based on time and a gain factor.

3. The street lighting assembly according to claim 2, further comprising a housing, wherein the LED light device is disposed within a confine of the housing; a temperature sensor disposed within the housing, the temperature sensor being coupled to the processor and configured to provide a measurement of the temperature to the processor.

4. The street lighting assembly according to claim 3, the street lighting assembly further comprising an electrical parameter meter disposed within the node, the electrical parameter meter coupled to a power mains of the LED lighting device and the processor, the electrical parameter meter being configured to measure one or more of a voltage, current or power consumption of the LED light device.

5. The street lighting assembly according to claim 1, wherein the processor is configured to determine the correction factor using a non-linear correction algorithm.

6. The street lighting assembly according to claim 1, wherein the node assembly comprises a connector, the connector configured to enable the node assembly to be removably coupled to the LED light device and a power mains electrically coupled to the LED light device.

7. The street lighting assembly according to claim 6, further comprising an electrical meter disposed in the node assembly, the electrical meter configured to measure one or more of the electrical parameters of the LED light device and communicate the measured values to the processor.

8. The street lighting assembly according to claim 7, wherein the electrical meter comprises a digital measurement device.

9. The street lighting assembly according to claim 1, wherein the processor is further configured to determine if the detected temperature is within a range of pre-determined temperatures and apply the correction factor when the detected temperature is outside of the pre-determined range.

10. A method comprising:
determining a temperature of an operating environment for an electronic device;
measuring one or more electrical parameters associated with an operation of the electronic device in the operating environment; and
using a processor to execute machine readable instructions stored in a memory device, the machine readable instructions when executed by the processor being configured to cause the processor to:
determine a correction factor associated with the determined temperature; and
apply the determined correction factor to the one or more electrical parameters associated with the operation of the electronic device in the operating environment to adjust the measured electrical parameters for a temperature offset.

11. The method according to claim 10, wherein the processor is configured to calculate the correction factor as a function of the detected temperature based on time and a gain factor.

12. The method according to claim 10, wherein the processor is configured to determine the correction factor from a database of predetermined correction factors.

13. The method according to claim 10, wherein the execution of the machine readable instructions by the processor causes the processor to determine if the measured temperature is within a range of predetermine temperatures and determine the correction factor is the measure temperature is outside the range of predetermined temperatures.

14. The method according to claim 10, wherein the electronic device comprises an LED street light.

15. The method according to claim 10, wherein the electronic device comprises a utility meter.
